(19) United States
(12) Patent Application Publication
(10) Pub. No.: US 2015/0215851 A1
(43) Pub. Date: Jul. 30, 2015

(54) MOBILE TELECOMMUNICATIONS NETWORK, MOBILE RELAY NODE, AND MOBILE TELECOMMUNICATIONS SYSTEM

(71) Applicant: Sharp Kabushiki Kaisha, Osaka-shi (JP)

(72) Inventor: Sivapathalingham Sivavakeesar, Berkshire (GB)

(21) Appl. No.: 14/419,319

(22) PCT Filed: Aug. 8, 2013
(86) PCT No.: PCT/JP2013/004790

§ 371 Date: Feb. 3, 2015

(30) Foreign Application Priority Data
Aug. 9, 2012 (GB) 1214253.5

(51) Int. Cl. H04W 48/16; H04B 7/15

(52) U.S. Cl. CPC H04W 48/16; H04B 7/15

(57) ABSTRACT

A mobile telecommunications network comprising an operations and maintenance centre operable to maintain operation and maintenance of the network. The network also comprises a plurality of cells, each comprising a physical cell identifier (PCI), wherein some of the cells are fixed cells, and some of the cells are mobile cells. A first cell comprises an eNB operable to host an automatic neighbour relation (ANR) function, including a neighbour relation table (NRT), to maintain details of cells from the plurality of cells neighbouring the first cell. The eNB maintains, in the NRT, information regarding whether a neighbouring cell is fixed or mobile.

### TECHNICAL FIELD

The present invention relates to relay node backhaul handover, and particularly mobile relay node backhaul handover, as applicable in 3GPP Long Term Evolution (LTE)-Advanced. Particularly, the present invention relates to avoidance of PCI collision.

### BACKGROUND ART

The increase of mobile data, together with an increase of mobile applications (such as streaming content, online gaming and television and internet browsers) has prompted work on the LTE standard. This has been superseded by the LTE-A standard.

LTE-A or LTE Advanced is currently being standardized by the 3GPP as an enhancement of LTE. LTE mobile communication systems being deployed as a natural evolution of GSM (registered trademark) and UMTS.

Being defined as 3.9G (3G+) technology, LTE does not meet the requirements for 4G, also called IMT Advanced, that has requirements such as peak data rates up to 1 Gbps.

In April 2008, 3GPP agreed to the plans for future work on Long Term Evolution (LTE). A first set of 3GPP requirements on LTE Advanced was approved in June 2008. The standard calls for a peak data rate of 1 Gbps and also targets faster switching between power states and improved performance at the cell edge. Further details may be found at www.3gpp.com.

FIG. 1 shows a simplified arrangement of an LTE wireless telecommunications network 10. There is provided a base station 12—the eNodeB, or more simply an eNB—a relay node 14 (sometimes abbreviated to RN) and two user equipments 16, 18 (sometimes abbreviated to UEs). Further details of LTE architecture may be found at www.3gpp.org.

The relay node comprises a two-way wireless link to the eNB. It will be understood that each relay in the network will have a link to a controlling eNB. The link from the relay node to the eNB is often termed the backhaul link, and is achieved by the Un interface. Each eNB is linked to the core network, and this link is the eNB's backhaul link. The controlling eNB is sometimes referred to as a donor eNB, or D-eNB. A D-eNB controls network traffic within a domain. Said domain may include a plurality of further nodes. Cells located geographically next to one another may be termed neighbouring cells. Hence, a neighbour may be considered as a cell within a predetermined geographical range of an eNB.

A UE connected directly to a D-eNB is considered to be directly linked, or to comprise a direct link. Such a UE may be termed a Macro UE, or a M-UE. UE 16 shown in FIG. 1 is an M-UE.

A UE's connection to a relay node is termed an access link. A UE connected to a relay node is often termed R-UE. UE 18 shown in FIG. 1 is an R-UE.

During normal operations, a UE or a RN may undergo a handover from a source access point to a target access point. (and, hence from a source cell to a target cell).

Relaying

Relaying is considered as an economical way of extending the coverage of a wireless communication system by improving the cell-edge throughput and system capacity. In LTE-A, relays are generally defined in two categories: type 1 and type 2.

Type 1 relay nodes have their own PCI (Physical Cell ID) and are operable to transmit its common channel/signals. UEs receive scheduling information and HARQ feedback directly from the relay node. It is also possible for type 1 relay nodes to appear differently to eNBs to allow for further performance enhancement. Type 1 relay nodes are considered to have UE-part and an eNB-part—with the UE-part a D-eNB sees a relay as a UE whereas with an eNB part an R-UE sees a relay as an eNB. More details of this arrangement may be found in GB2475906 by Sharp Kabushiki Kaisha, the details of which are incorporated herein by reference.

Type 1 relays can be considered as containing the functionalities of both an eNB (control node) and UE (user equipment), depending on how its functionalities are viewed. Thus, in the backhaul link the relay node behaves like a UE (which is operated by the functionality of a UE), whereas in the access link it behaves like an eNB (which is operated by the functionality of an eNB). Or, put another way, the D-eNB sees the relay node as a UE, whereas the UE sees the relay node as an ordinary eNB.

By contrast, type 2 relay nodes do not have a separate PCI, and are transparent to UEs.

A PCI is present in a P-SCH (Primary Synchronisation Channel), a S-SCH (Secondary Synchronisation Channel), and a RS (Reference Signal). The PCI allows a cell to be correctly configured and allows a UE or a RN (Relay Node) to synchronise with the cell. The maximum number of PCI sequences is 504 (that is divided into 168 groups) to ensure compatibility with base stations complying with the TS36.211 and TS36.300 standards. Due to this finite number of PCI sequences, a problem may arise when two access points (and, hence, cells) have the same PCI and are accessible by one device. This is termed a PCI collision.

Automatic Neighbour Relation (ANR)

With an introduction of moving cells, the importance of ANR will be soon realized. According to TS 36.300, the entirety of which is incorporated herein by reference, the purpose of the ANR function is to relieve the operator from the burden of manually managing Neighbour Relations (NRs). FIG. 2 (repeated from TS36.300) illustrates ANR and its environment. The ANR function resides in the eNB and manages the conceptual Neighbour Relation Table (NRT). Located within ANR, the Neighbour Detection Function detects new neighbours and adds them to the NRT. ANR also contains the Neighbour Removal Function which removes outdated NRs. The Neighbour Detection Function and the Neighbour Removal Function are implementation specific. Also shown in FIG. 2, the eNB is connected to an O&M (Operations and Maintenance) centre, which operates and maintains the regional network. It will be appreciated by the skilled reader that there may be multiple O&M centres in an overall network, each having responsibility for a region. As a comparison, a single NM (Network Management) centre is responsible for maintaining the network as a whole.

A Neighbour cell Relation (NR) in the context of ANR is defined as follows:

If a Neighbour Relation exists between a source cell to a target cell, the eNB controlling the source cell:

a) Knows the ECGI/CGI and PCI of the target cell.

b) Has an entry in the NRT for the source cell identifying the target cell.

c) Has the attributes in this NRT entry defined, either by O&M or set to default values.

An eNB keeps a NRT (see FIG. 2) that identifies each neighbour cell. For each NR, the NRT contains the Target Cell Identifier (TCI), which identifies the target cell. In the example shown in FIG. 1, a UE 16 is connected to a D-eNB 12. That D-eNB 12 will keep an NRT, which identifies each of its neighbour D-eNBs (and, hence, their associated cells). In FIG. 1, the NRT of the D-eNB 12, will identify the other D-eNB or relay node 14.

For E-UTRAN, the TCI corresponds to the E-UTAN Cell Global Identifier (ECGI) and Physical Cell Identifier (PCI) of the target cell. Furthermore, each NR has three attributes: a “NoRemove”; a “NoHO”; and a “NoX2” attribute. These attributes have the following definitions:

No Remove: If checked, the eNB shall not remove the Neighbour cell Relation from the NRT.

No HO: If checked, the Neighbour cell Relation shall not be used by the eNB for handover reasons.

No X2: If checked, the Neighbour Relation shall not use an X2 interface in order to initiate procedures towards the eNB parenting the target cell.

Neighbour cell Relations are unidirectional, while an X2 link is bidirectional.

The neighbour information exchange, which occurs during the X2 Setup procedure or in the eNB Configuration Update procedure, may be used for ANR purpose.

The ANR function also allows O&M to manage the NRT. O&M can add and delete

NRs. It can also change the attributes of the NRT. The O&M system is informed about changes in the NRT. For example, if a mobile relay node were to be connected to a D-eNB 12 (in FIG. 1) and subsequently be handed over to another D-eNB 14, the mobile relay may be deleted from the NRT of the first D-eNB 12 and may be added to the NRT of the second D-eNB 14. This can be seen in FIG. 5, which shows an example of LTE architecture with a MRN.

In FIG. 5, the MRN 26 is mounted on train 40. As will be appreciated, trains travel at high speeds, and as such will pass through multiple domains (or cells), and as such have to interact with multiple D-eNBs 14, 12. In FIG. 5, the MRN 26 is connected to a first D-eNB 14 (shown by a solid, two-ended arrow), but as it moves away from this node and towards a second D-eNB 12, it will become necessary for the MRN 26 to be handed over from the first D-eNB 14 to the second D-eNB 12 (shown by a dashed, two-ended arrow). It may then be required that the MRN 26 is deleted from the NRT of the first D-eNB 14 and may be added to the NRT of the second D-eNB 12.

Intra-LTE/frequency ANR Function

The ANR (Automatic Neighbour Relation) function relies on cells broadcasting their identity on global level, E-UTRAN Cell Global Identifier (ECGI).

With reference to FIG. 1, the function works as follows:

The eNB 12 serving cell A 12′ has an ANR function. As part of the normal call procedure, the eNB 12 instructs each UE 16 to perform measurements on neighbour cells 14′. The eNB 12 may use different policies for instructing the UE 16 to do measurements, and when to report them to the eNB 12. This measurement procedure is as specified in TS 36.331, and is shown in FIG. 3.

1. The UE 16 sends a measurement report regarding cell B 14′. This report contains Cell B's 14′ PCI, but not its ECGI.

When the eNB 12 receives a UE measurement report containing the PCI, the following sequence may be used.

2. The eNB 12 instructs the UE 16, using the newly discovered PCI as parameter, to read the ECGI, the TAC and all available PLMN ID(s) of the related neighbour cell 14′. To do so, the eNB 12 may need to schedule appropriate idle periods to allow the UE 16 to read the ECGI from the broadcast channel of the detected neighbour cell. How the UE 16 reads the ECGI is specified in TS 36.331.

3. When the UE 16 has found out the new cell's 14′ ECGI, the UE 16 reports the detected ECGI to the serving cell eNB 12. In addition the UE 16 reports the tracking area code and all PLMN IDs that have been detected. If the detected cell is a CSG or hybrid cell, the UE 16 also reports the CSG ID to the serving cell eNB 12.

4. The eNB 12 decides to add this neighbour relation, and can use PCI and ECGI to:

a) Lookup a transport layer address to the new eNB 14.

b) Update the Neighbour Relation List.

c) If needed, setup a new X2 interface towards this eNB 14 as described in section 22.3.2 of TS 36.300.

Information on Inter-RAT/Inter-frequency Automatic Neighbour Relation Function can be found on Section 22.3.4 of TS 36.300.

Mass Transit Systems

High speed public transportation is being deployed worldwide at a rapid pace. It is therefore desirable to include relay nodes (RNs) onto such transportation. Such RNs are typically termed mobile relay nodes (MRNs). Indeed, MRNs have recently started drawing the attention of the 3GPP because of their ability to minimize or completely avoid the high and bursty signalling load at the time of group mobility. In such a situation a MRN being mounted on a vehicle can perform a group mobility instead of individual mobility procedures for every user equipment (UE). In other words, UEs connected to a MRN do not have to individually handover between D-eNBs as they pass through different domains; the MRN can maintain connection with each UE and handover its backhaul link between D-eNBs.

With an introduction of Automatic Neighbour Relation (ANR) in LTE, a D-eNB can determine the details about neighbour cells (i.e. the cells that are located locally to the D-eNB). According to 3GPP specifications, the purpose of the ANR functionality is to relieve the operator from the burden of manually managing Neighbour Relations (NRs).

The ANR function resides in the eNB and comprises three functions: a Neighbour Detection Function; a Neighbour Removal Function; and a NRT Management Function, as shown in FIG. 1. The Neighbour Detection Function is located within the ANR, and causes the D-eNB to find new neighbours and add them to the NRT. An existing Neighbour cell Relation (NR) from a source cell to a target cell means that an eNB controlling the source cell knows the E-UTRAN Cell Global Identifier/Cell Global Identifier (ECGI/CGI) and Physical Cell Identifier (PCI) of the target cell and has an entry in the NRT for the source cell identifying the target cell.

A Mobile Relay Node (MRN) may be mounted on the top of a train and serves the UEs inside the carriages, as shown in FIG. 5. When the train moves from a first cell (served by a first D-eNB 14) to a second cell (served by a second D-eNB 12), a handover is performed for the MRN 26 rather than for each of the UEs individually. However, as the train 40 moves across the cells along the railway, the PCI of the MRN cell may collide with neighboring cells served by Evolved Node Bs (eNBs) 14, 12 along the track, or with MRNs mounted on other trains that also use the railway. As the MRN 26 moves across different cells, its PCI may collide with the PCI of a fixed access point.

A conventional solution to avoid PCI collision between a moving cell and a fixed cell uses a dedicated but separate PCI pool for both fixed nodes and mobile relays. This can prevent a PCI collision between a moving cell and a fixed cell in a small region, but does not account for a PCI collision when two or more mobile relays approach each other. As the mobile relays share the same PCI pool, they may be assigned the same PCI. The mobile relays could then cause a PCI collision when they approach each other.

In a train network, this problem may be mitigated by careful planning. However, when train operators change the train compartments and/or operate the trains in different geographic areas, it becomes difficult to account for PCI requirements in addition to train timetable requirements. Additionally, a central train terminus may force relay nodes on many trains to be connected to the same fixed node at one time, thereby increasing the chance of a PCI collision. Similar problems may occur with mobile relays mounted on other vehicles.

The present invention has been created with the above problems in mind. Hence, it is an object of the present invention to provide an arrangement for completely avoiding PCI collision. Particularly, it is an object of the present invention to provide an arrangement for avoiding PCI collision for a moving cell without having to split the already limited PCI pool. A further object of the present invention is to provide a PCI collision avoidance arrangement that accounts for relative movement of a vehicle, upon which a mobile relay is mounted, at the discretion of an operator of the vehicle.

### SUMMARY OF INVENTION

According to a first aspect of the present invention, there is provided a mobile telecommunications network comprising:

one or more operations and maintenance centres operable to maintain operation and maintenance of the network;

a plurality of cells, each comprising a physical cell identifier (PCI), wherein some of the cells are fixed cells, and some of the cells are mobile cells, wherein,

a first cell comprises an eNB operable to host an automatic neighbour relation (ANR) function, including a neighbour relation table (NRT), to maintain details of cells from the plurality of cells neighbouring the first cell, wherein,

the eNB maintains, in the NRT, information regarding whether a neighbouring cell is fixed or mobile.

According to a second aspect of the present invention there is provided a mobile relay node forming a mobile cell comprising a physical cell identifier (PCI), the mobile relay node operable to move within a mobile telecommunications network, said mobile telecommunications network comprising a plurality of cells each with respective physical cell identifiers (PCIs), wherein,

as said mobile relay node moves between cells in the network, it is operable to monitor PCIs of cells that it presently neighbours, wherein,

if the relay node detects that its PCI conflicts with that of a neighbouring cell, the relay node is operable to change its PCI.

According to a third aspect of the present invention there is provided a mobile telecommunications system, comprising:

a first eNB to which a mobile relay node is attached, said mobile relay node comprising a physical cell identifier (PCI);

a second eNB, controlling one or more cells, each with a respective PCI;

a third eNB, which is a neighbour of the second eNB, controlling one or more cells, each with a respective PCI, wherein,

each of said eNBs comprise an automatic neighbour relation function, such that each eNB is aware of PCIs of cells controlled by neighbouring eNBs,

when said first eNB hands over the mobile relay node to the second eNB, said second eNB determines whether or not the PCI of the mobile relay node conflicts with any of the PCIs of the cells controlled by the third eNB, wherein, if a conflict occurs, said second eNB prompts said mobile relay node to change its PCI.

According to a fourth aspect of the present invention there is provided a mobile telecommunications system, comprising:

a eNB;

a first mobile relay node and a second mobile relay node, wherein each mobile relay node comprises first and second physical cell identifiers (PCIs), wherein, if said PCIs are the same, said eNB is operable to prompt one of the first mobile relay node and a second mobile relay node to change their PCI.

In order that the present invention be more readily understood, specific embodiments and aspects thereof will now be described with reference to the accompanying drawings.

### BRIEF DESCRIPTION OF DRAWINGS

FIG. 1 shows an overview of LTE architecture.

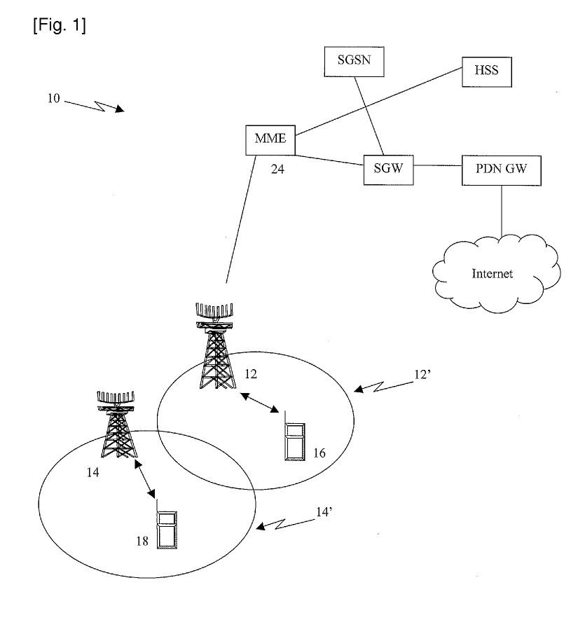

FIG. 2 shows a prior art interaction between an eNB and O&M due to ANR.

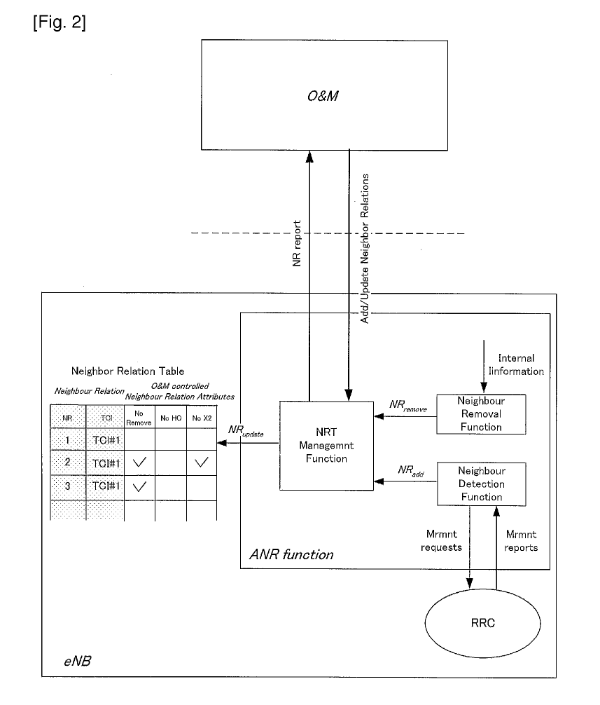

FIG. 3 shows a representation of an ANR function.

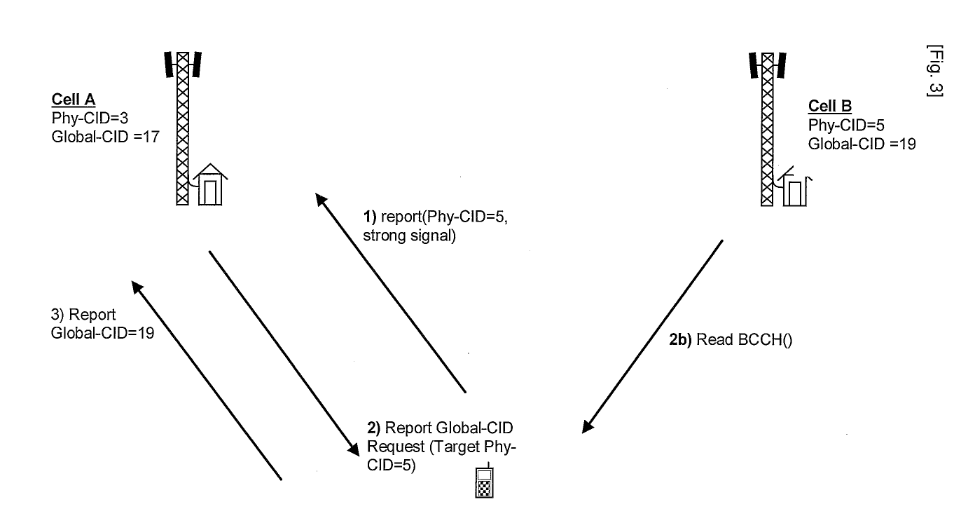

FIG. 4 shows a diagram for a section of a wireless telecommunications network.

FIG. 5 shows a sub-set of the network of FIG. 4.

FIG. 6 shows a flow diagram of operational procedures in accordance with an embodiment of the present invention.

### DESCRIPTION OF EMBODIMENTS

The present invention is primarily concerned with mobile relay nodes—typically abbreviated to MR—and their handover within the LTE-A wireless networks. However, the present arrangement is also applicable to static relay nodes when said static relay node is subject to a handover between base stations for load balancing purposes. It is also applicable when a new static relay node is added to an existing network. In general, the present invention uses a Neighbour Relation Table (NRT) of a D-eNB to determine if a PCI collision will occur.

A mobile relay (MR) is mobile through a wireless telecommunications system. As the MR traverses across different cells its own physical cell identifier (PCI) may collide with that of a fixed cell or another moving cell. This is important because many network signals, such as P-SCH, S-SCH, RS, all carry either the PCI or the group to which it belongs.

There is a maximum of 510 PCI sequences that are defined and hence such a resource is finite and scarce. Thus, there will always be the need to reuse PCI sequences within a network. Problems of PCI collision would not occur if all access nodes (and hence cells) where fixed. The advent of mobile relays has meant that it is possible for cells with the same PCI to collide.

PCI collision between a moving cell and a fixed cell can be avoided by using a dedicated but separate PCI pool for both fixed nodes and mobile relays. This solution solves the problem of mobile relay node PCIs colliding with fixed access node PCIs. However, PCI collision between two mobile relay node may still occur. The likelihood of collision would depend upon the number of PCI sequences reserved for mobile relays.

A particular area where PCI collision between mobile relay nodes may occur is on a train network. The problem can be exacerbated because train operators may change the train compartments randomly and operate in different areas at their own discretion.

Thus, it is desirous that any PCI collision avoidance mechanism should not deprive train or coach operators of the freedom of operating the same coach on different routes as and when needed. Hence, keeping different PCI pools is not a straight-forward answer.

The present arrangement provides a plurality of solutions that are capable of handling a situation when two or more E-UTRAN nodes having the same PCI get close to each other. These solution are such that it is not necessary to allocate a dedicated PCI pool.

Particularly, three embodiments are presented, each of which avoid PCI collisions without having to split the finite PCI pool of PCI sequences.

### Embodiment 1

A mobile relay node is operable to sporadically monitor its backhaul link to a controlling D-eNB for PCI detection of the neighboring cells. Given that relay nodes may be considered to comprise two aspect—a UE-part and a eNB-part—the relay can use its UE-part for this purpose. As soon a conflicting PCI is detected by the UE-part, the given mobile relay changes its own PCI being used on the access link to one that is different from those of the neighboring cells and inform its R-UEs about the change appropriately.

Thus, this embodiment provides a mobile relay node that forms a mobile cell comprising a PCI. The mobile relay node operable to move within a mobile telecommunications network, said network comprising a plurality of cells each with respective PCIs. As the mobile relay moves between cells in the network, it is operable to monitor PCIs of cells that it presently neighbours, such that if the relay node detects that its PCI conflicts with that of a neighbouring cell, the relay node is operable to change its PCI. It will be appreciated that the relay node is typically a type 1a or type 1b relay.

### Embodiment 2

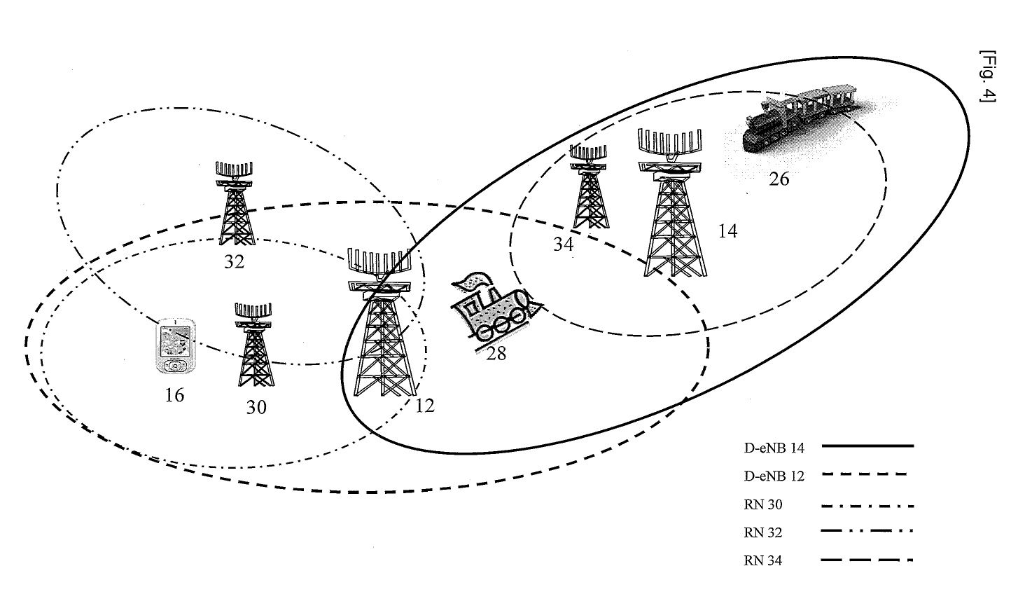

The present embodiment is described with reference to FIG. 4. This figure shows two D-eNBs 12, 14, two mobile relay nodes 26, 28, three fixed relay nodes 30, 32, 34 and a UE 16.

The introduction of Automatic Neighbour Relation (ANR) in LTE, allows a given D-eNB to acquire details about the cells that are located in its local neighbourhood. For example, D-eNB 12 is operable to acquire details of the cells associated with D-eNB 14, and relay nodes 30, 32 associates therewith. Likewise, D-eNB 14 can acquire details the cells associated with D-eNB 12 and relay node 34.

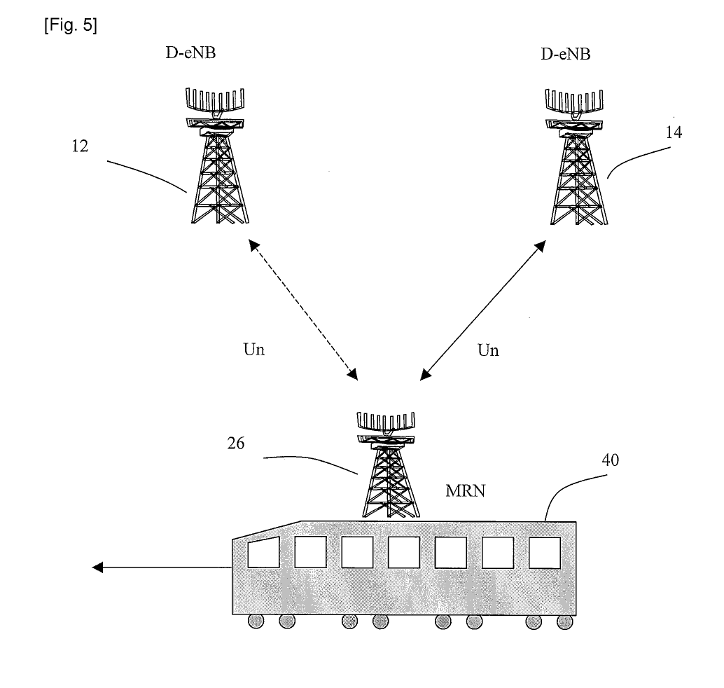

FIG. 5 shows a simplified version of part of FIG. 4. Only mobile relay 26 and D-eNBs 12, 14 are shown. As the mobile relay moves away from D-eNB 14 towards D-eNB 12, it will be handed over from D-eNB 14 to D-eNB 12. Thus the backhaul link of mobile relay 26 will be handed over between the two D-eNBs.

It will be appreciated that mobile relay 26 may have the same PCI as that of the cells of mobile relay 28, D-eNB 12 or fixed relay nodes 30, 32. If so, and if mobile relay 26 continues towards D-eNB 12, there will be a PCI collision.

According to the present embodiment, by using ANR functionality, PCI collision can be avoided well before any handover of a mobile relay.

Two scenarios in accordance with the present embodiment will now be described. The first assumes that mobile 26 has the same PCI as fixed relay 30. Fixed relay 30 is associated with D-eNB 12.

When the mobile relay 26 is handed over to D-eNB 12 from D-eNB 14, it will be notified about a possible PCI collision. This is because, through ANR, D-eNB 14 will be aware of the PCIs of cells belonging to neighbouring eNBs—D-eNB 12 in this case. Accordingly, with this mechanism in place, D-eNB 14 will prompt mobile relay 26 to change its PCI before it gets closer to the cell of fixed relay 30.

In a second scenario, suppose that the PCI of mobile relay 28 is same as that of mobile relay 26 belonging to D-eNB A. In the present embodiment, one of the mobile relay nodes will be prompted to change its PCI by the D-eNB 14. The mobile relay selected to change its PCI is dependent upon which mobile relay 26, 28 is handed over to D-eNB 14 last.

However, suppose that mobile relay 26 has already been served by D-eNB 14 before mobile relay 28 is handed over to D-eNB 14. In this case, mobile relay 28 will be prompted by D-eNB 14 to change its PCI to avoid future collision with mobile relay 26.

### Embodiment 3

A third embodiment will now be described.

As seen from TS 36.300, an eNB is responsible for hosting the ANR functionality. TS 36.300, in subsection 22.3.5, also specifies two frameworks that are used to assign PCIs to eNBs. Accordingly, at the outset, the O&M centre either assigns a PCI to an eNB or provides a list of PCIs for an eNB to select from.

The present embodiment specifically aligns with the texts of TS 36.300 and especially with sections 22.3.2a and 22.3.5. According to Section 22.3.2a, every eNB in the network is required to determine what cells are within its neighbourhood, their TCIs, and whether X2 is possible. This requirement is implemented through the automatic neighbour relation (ANR) function.

On top of the existing ANR functionality, the present embodiment defines that an eNB is also responsible to maintain additional information regarding every neighbouring cell it discovers. This additional information is maintained in the eNB's Neighbour Relation Table (NRT).

Preferably, the eNB will maintain an additional column in the NRT to specify the cell type of a neighbouring cell. This cell type defines whether the cell is mobile cell (ie formed by a mobile relay node) or a fixed cell (formed by a fixed or static access node).

In the present arrangement, if a moving cell is detected, the eNB will also determine whether said moving cell's PCI may collide with that of another neighbouring cell identified and listed in its Neighbour Relation Table (NRT). If this is the case, the eNB will prompt the relevant O&M for a necessary action, such as requiring the mobile relay node of the moving cell to change its PCI. It is particular preferred that the eNB identifies the O&M associated with the moving cell, and request it to carry out an action similar to that specified in 22.3.5. It is particularly preferred that the eNB supplies information regarding what PCIs the mobile relay has to avoid when contacting the O&M. With that information, the O&M associated with the moving cell can make corrective action well before any collision.

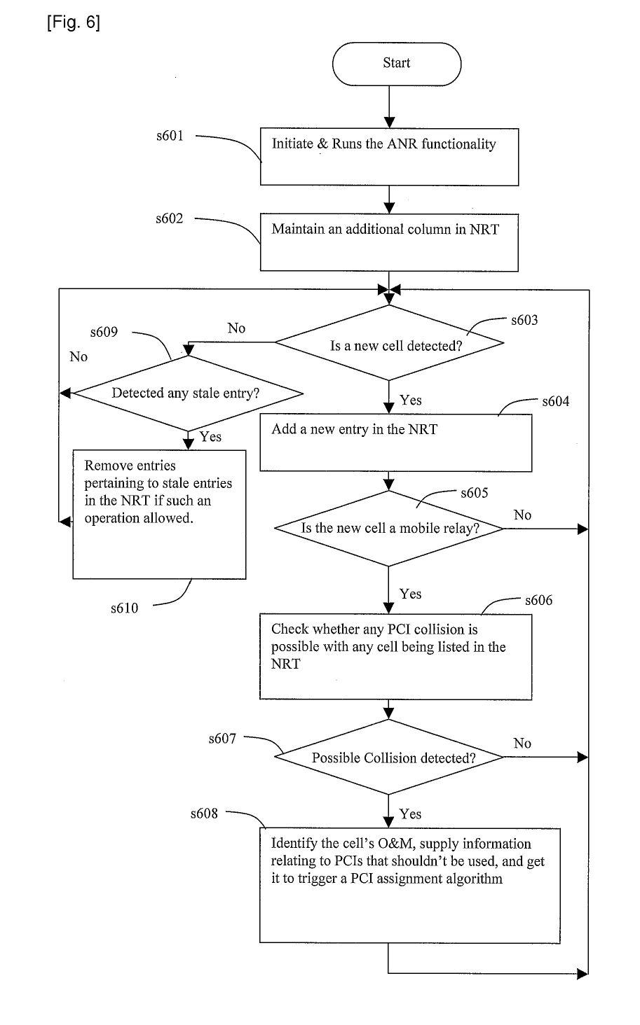

The additional set of operational procedures involved as part of ANR functionality as proposed by present embodiment is depicted in FIG. 6. This set of procedures is executed within a D-eNB that hosts the ANR functionality as specified by TS 36.300.

Specifically, FIG. 6 shows process carried out by a D-eNB in accordance with the present embodiment. The D-eNB will have ANR functionality as specified by TS36.300. In general, a D-eNB will maintain an additional piece of information for every cell it discovers once ANR functionality is operational. This requires the NRT to store additional information, which specifies whether each discovered cell is of fixed (i.e., non-moving) or moving cell (e.g., an MRN) type.

In some embodiments, the additional information may be stored in an additional column in the NRT. With this additional column, the D-eNB will start detecting a new cell. If the detected cell is of a moving cell type, the D-eNB will further check whether the PCI of the newly discovered moving cell collides with a PCI of any of the cells listed in the NRT. If this is the case, the D-eNB will:

a) Identify the O&M of the newly discovered moving cell;

b) Indicate PCIs that are to be avoided when initiating a PCI assignment algorithm;

and

c) Instruct the identified O&M to execute the PCI assignment algorithm.

The process of FIG. 6 begins, at step s601, with the D-eNB initiating and running ANR functionality. Preferably ANR functionality in the present embodiment is in accordance with TS36.300. In addition to TS36.300 functionality, a process of the present embodiment maintains an additional column in the NRT at step s602. That additional column indicates whether a NR in the NRT relates to a moving cell (such as a MRN) or a fixed cell (such as a static D-eNB or RN).

At step s603, it is determined whether or not the Neighbour Detection Function of the ANR function has detected a new cell. If a new cell is detected, the process proceeds to step s604, if not, the process proceeds to step s609.

At step s604 the new cell is added to the NRT. This may be accomplished using the Neighbour Detection Function. It is then determined, at step s605, whether the new cell is related to a moving access point or a fixed access point (such as a D-eNB). For the purposes of this explanation, a MRN will used as an example of a moving access point, although the present embodiment is applicable to other moving access point. If the new cell relates to a fixed access point, the process returns to step s603, and the D-eNB determines if another new cell is detected.

If it has been determined that the new cell relates to a MRN, the D-eNB determines if the PCI of the new MRN could collide with the PCIs related to the cells already indicated in the NRT (s606). At step s607 the process is directed depending on the results of that determination. If a PCI collision is possible, the process proceeds to step s608. Otherwise, the process returns to step s603 and the D-eNB determines if another new cell is detected.

At step s608 the D-eNB identifies the relevant O&M, which will be used to assign a new PCI to the new MRN. The D-eNB also provides PCIs that are already in use. This may be achieved by sending a list of PCIs from the NRT. Additionally, the D-eNB instructs the relevant O&M to execute a PCI assignment algorithm. PCI assignment algorithm may cause the O&M to either indicate a specific new PCI for the new MRN, or provide a list of PCIs from which the new MRN will select a new PCI. The relevant O&M may be the O&M of the cell related to the new MRN.

When a new PCI has been assigned to the new MRN, the process reverts to to step s603 and the D-eNB determines if another new cell is detected.

If the D-eNB does not detect a new cell, the process will proceed to step s609, in which the D-eNB will check the NRT to determine if there are any redundant, or “stale”, entries. Such a stale entry may be caused by a MRN no longer being connected to the D-eNB, or the neighbour access points of the D-eNB. It is advantageous to remove these stale entries from the NRT so as to maintain as many free PCIs as possible for new MRNs (s610).

If a stale entry is detected, the D-eNB removes that entry from the NRT. This may be done with the Neighbour Removal Function of the ANR, in accordance with TS36.300. The process then proceeds back to step s603 to determine if a new cell is detected by the D-eNB. If there are no stale entries in the NRT, the process reverts back to step s603.

Accordingly, once the ANR functionality is operational in the D-eNB, it will maintain an additional piece of information for every cell it discovers. One operational example would involve adding an additional column in the Neighbour Relation Table (NRT) to specify whether each discovered cell is of fixed (i.e., non-moving) or moving cell (e.g., mobile relay) type. With this additional column, a D-eNB will start detecting a new cell. If the detected cell is of a moving cell type, the D-eNB will further check whether the PCI of the newly discovered moving cell collides (i.e., is same as the) PCI of any of the listed cells in the NRT. If this is the case, the D-eNB will identify the newly discovered moving cell's O&M, supply information in terms of what PCIs it needs to avoid, and prompt the identified O&M to trigger a PCI assignment algorithm.

Accordingly, it will be appreciated that there is provided a mobile telecommunications network with one or more operations and maintenance centres operable to maintain operation and maintenance of the network. Said network comprises plurality of cells, each comprising a PCI, wherein some of the cells are fixed cells, and some of the cells are mobile cells. In the network, a first cell comprises an eNB operable to host an ANR function, including a NRT, to maintain details of cells from the plurality of cells neighbouring the first cell. The eNB maintains, in the NRT, information regarding whether a neighbouring cell is fixed or mobile.

Preferably, the eNB is operable to detect new neighbouring cells, wherein if a newly detected cell is a mobile cell, said eNB is operable to determine whether or not the PCI of the newly detected mobile cell matches a PCI already in its NRT. Furthermore, the eNB is operable to identify the operations and maintenance centre for the newly detected mobile cell and request that it changes the cell's PCI if its PCI collides with that of an existing cell in the NRT by initiating a PCI assignment algorithm. The eNB is operable to indicate to the operations and maintenance centre which PCIs need to be avoided when initiating the PCI assignment algorithm.

Preferably, the eNB is operable to detect new neighbouring cells, wherein if a newly detected cell is a mobile cell, said eNB is operable to determine whether or not the PCI of the newly detected mobile cell matches a PCI already in its NRT.

It is particularly preferred that the eNB is operable to identify the operations and maintenance centre for the newly detected mobile cell and request that it changes the cell's PCI if its PCI collides with that of an existing cell in the NRT by initiating a PCI assignment algorithm.

Preferably, the eNB is operable to indicate to the operations and maintenance centre which PCIs need to be avoided when initiating the PCI assignment algorithm.

In preferred embodiments access nodes forming the respective fixed cells comprise eNBs and type 1, type 1a and type 1b relay nodes.

Preferably the relay node is a type 1a or type 1b relay.

It is preferred that the mobile relay node comprises a backhaul link to a first eNB, wherein the backhaul link is handed over to a second eNB as required by the mobile relay node's mobility, wherein the mobile relay node monitors its backhaul link for information regarding PCIs of neighbouring cells.

Preferably the mobile relay node continuously monitors its backhaul link in order to detect any PCI collision with the eNB.

Preferably the last of the first and second mobile relay nodes handed over to the eNB is prompted to change its PCI.

It is preferred that, if the first mobile relay node has previously been served by the eNB, the second mobile relay node will be prompted by the eNB to change its PCI.

It will be appreciated that the above described embodiments are provided for understanding of the invention, and should not be used to limit the invention, which is defined by the attached claims.

1-13. (canceled)

14. A base station controlling one or more cells and connected to one or more operations and maintenance centres which operate and maintain a network comprising:
a controller configured to operate an automatic neighbour relation (ANR) function, including a neighbour relation table (NRT), to maintain information regarding at least one cell neighbouring the cell controlled by the base station, wherein, the controller maintains, in the NRT, the information further including information regarding whether a neighbouring cell is fixed or mobile.

15. A base station according to claim 14, wherein the base station is configured to detect new neighbouring cells, wherein if a newly detected cell is a mobile cell, the base station is configured to determine whether or not the PCI of the newly detected mobile cell matches a PCI already in its NRT.

16. A base station according to claim 15, wherein the base station is configured to identify the operations and maintenance centre for the newly detected mobile cell and request to change the cell's PCI if its PCI collides with a PCI of an existing cell in the NRT by initiating a PCI assignment algorithm.

17. A base station according to claim 16, wherein the base station is configured to indicate to the operations and maintenance centre which PCIs need to be avoided when initiating the PCI assignment algorithm.

18. A mobile relay node forming a mobile cell comprising a physical cell identifier (PCI), the mobile relay node is configured to move within a mobile telecommunications network, said mobile telecommunications network comprising a plurality of cells each with respective physical cell identifiers (PCIs), wherein,
as said mobile relay node moves between cells in the network, the mobile relay node is operable to monitor PCIs of cells that it presently neighbours, wherein,
if the mobile relay node detects that its PCI conflicts with a PCI of a neighbouring cell, the mobile relay node is operable to change its PCI.

19. A mobile relay node according to claim 18, wherein
said relay node is a type 1a or type 1b relay.

20. A mobile relay node according to claim 18, wherein the mobile relay node comprises a backhaul link to a first base station, wherein the backhaul link is handed over to a second base station as required by the mobile relay node's mobility, wherein the mobile relay node monitors its backhaul link for information regarding PCIs of neighbouring cells.

21. A mobile relay node according to claim 20, wherein the mobile relay node continuously monitors its backhaul link in order to detect any PCI collision with the base station.

22. A second base station, in a network including a mobile relay node comprising a physical cell identifier (PCI) and a first base station to which the mobile relay node is attached and the second base station controlling one or more cells, each with a respective PCI and a third base station, which is a neighbour of the second base station, controlling one or more cells, each with a respective PCI, wherein each of the base stations comprise an automatic neighbour relation function, such that each base station is aware of PCIs of cells controlled by neighbouring base stations, comprising:
a controller configured to operate an automatic neighbour relation function, wherein,
when the first base station hands over the mobile relay node to the second base station, the controller determines whether or not the PCI of the mobile relay node conflicts with any of PCIs of a cell controlled by a third base station, if a conflict occurs, the controller prompts the mobile relay node to change its PCI.

23. A base station controlling one or more cells each with a respective physical cell identifier (PCI) comprising a controller, wherein,
the controller determines whether or not the PCI of a first mobile relay node and a second mobile relay node conflict,
if a conflict occurs, the controller prompts one of the first and the second mobile relay node to change its PCI.

24. A base station according to claim 23, wherein the last of the first and second mobile relay nodes handed over to the base station is prompted to change its PCI.

25. A base station according to claim 24, wherein if the first mobile relay node has previously been served by the base station, the second mobile relay node will be prompted by the base station to change its PCI.
